(19) United States
(12) Patent Application Publication
(10) Pub. No.: US 2016/0100627 A1
(43) Pub. Date: Apr. 14, 2016

(54) Method of Manufacturing an Inexpensive and Disposable Smoking Pipe

(71) Applicant: John H. Jurewicz, New Lenox, IL (US)

(72) Inventor: John H. Jurewicz, New Lenox, IL (US)

(21) Appl. No.: 14/877,560

(22) Filed: Oct. 7, 2015

Related U.S. Application Data
(60) Provisional application No. 62/061,502, filed on Oct. 8, 2014.

(51) Int. Cl. A24F 1/32; B29C 41/02; B29C 41/46; B29C 41/00

(52) U.S. Cl. CPC A24F 1/32; B29C 41/003; B29C 41/02; B29C 41/46; B29L 2031/7414

(57) ABSTRACT

A method of manufacturing an inexpensive and disposable smoking pipe is first carried out by mixing a plurality of ingredients to develop a cohesive dough mixture. Then the cohesive dough mixture is transformed into a desired shaped of the smoking pipe that includes a smoking bowl, a draw channel, and a mouthpiece. The smoking pipe is then baked and cooled to create an outer crust from a first layer of egg wash. The smoking pipe is then intermittently baked and cooled to create a seasoning crust from a second layer of egg wash and a layer of seasoning. Once the outer crust and the seasoning crust are created, the smoking pipe is cooled down to the room temperature as the final step.

The current application claims a priority to the U.S. Provisional Patent application Ser. No. 62/061,502 filed on Oct. 8, 2014.

### FIELD OF THE INVENTION

The present invention relates generally to a smoking pipe. More specifically, the present invention is a method for manufacturing an inexpensive and disposable smoking pipe that is made up entirely of the materials used in a common pretzel.

### BACKGROUND OF THE INVENTION

Smoking is a widely practiced as a recreational activity that involves the combustion of herbs or tobacco product in order to release active substances found in said herbs and the tobacco product. The product of the combustion is then inhaled and absorbed through the lungs. Although many methods and mechanisms of smoking herbs currently exist, by far the most common method is the cigarette. Cigarettes generally comprise a quantity of tobacco that is packed tightly into a cylindrical sealed rolling paper. One end of the cigarette is lit in order to combust the tobacco and release nicotine from the tobacco leaves. While tobacco cigarettes are most commonly smoked this way, many other loose herbs and tobacco may be packed and rolled for consumption or may be placed within different smoking apparatus for consumption. Although many different apparatuses exist for the consumption of loose herbs and tobacco, these existing apparatuses tend to be expensive, difficult to clean, and cumbersome to use. As a result, many individuals desires a smoking apparatus that provides a solution for aforementioned problems.

It is an objective of the present invention to provide a method of manufacturing an inexpensive and disposable smoking pipe. The present invention provides a simple method for manufacturing the smoking pipe made up entirely of the materials used in a common pretzel. While sizes and shapes may vary within the smoking pipe, the pretzel material is considered to be the primary ingredient of the smoking pipe. The present invention demonstrates how the standard pretzel material can be transformed into the smoking pipe which comprises a draw channel, a mouthpiece end, and a smoking bowl. The smoking pipe is intended to be used as an inexpensive and disposable apparatus for smoking of herbs or tobacco product.

### BRIEF DESCRIPTION OF THE DRAWINGS

FIG. 1 is a flow chart illustrating the overall process of the present invention.

FIG. 2 is a flow chart illustrating the mixing process for the ingredients within the overall process of the present invention.

FIG. 3 is a flow chart illustrating the resting process for the cohesive dough mixture within the overall process of the present invention.

FIG. 4 is a flow chart illustrating the forming process for the smoking pipe within the overall process of the present invention.

FIG. 5 is a flow chart illustrating the second baking phase within the overall process of the present invention.

FIG. 6 is a flow chart illustrating the third baking phase within the overall process of the present invention.

FIG. 7 is a flow chart illustrating the final step of the smoking pipe within the overall process of the present invention.

### DETAIL DESCRIPTIONS OF THE INVENTION

All illustrations of the drawings are for the purpose of describing selected versions of the present invention and are not intended to limit the scope of the present invention.

The present invention is a method of manufacturing an inexpensive and disposable smoking pipe that is utilized for consumption of loose herbs and tobacco products. The smoking pipe is entirely made up of material used in a common pretzel and performs similar to the existing smoking apparatus; however, the smoking pipe provide an inexpensive and disposable solution for smoking loose herbs and tobacco products.

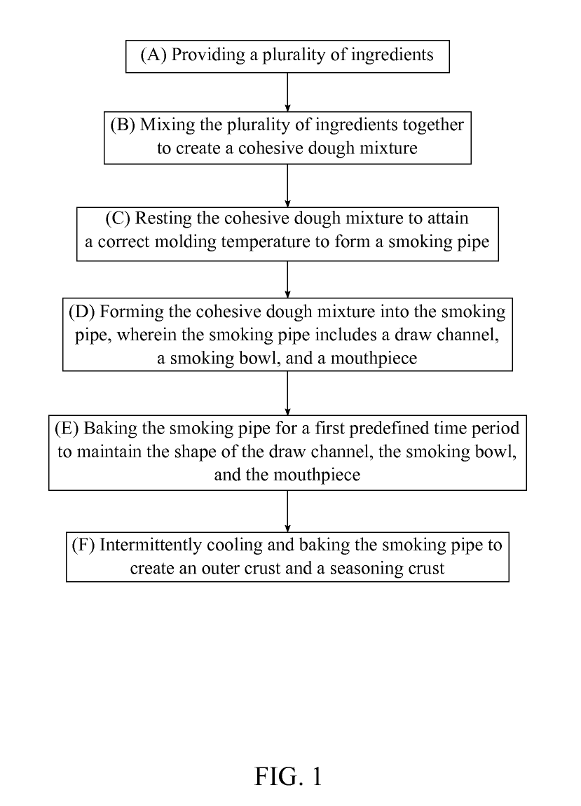

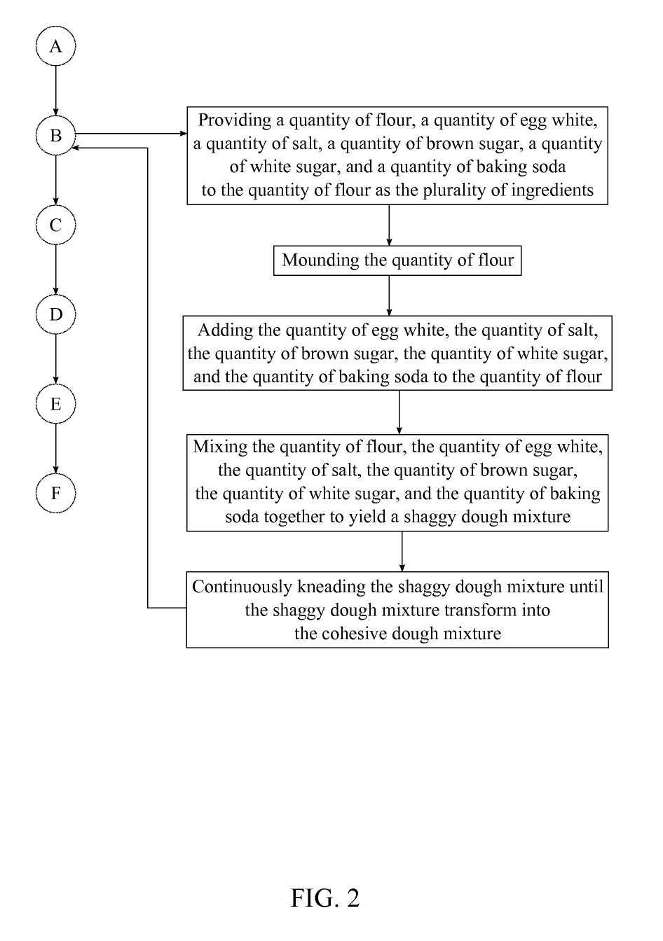

In order to begin the manufacturing process as illustrated in FIG. 1 and FIG. 2, a plurality of ingredients that includes a quantity of flour, a quantity of egg white, a quantity of salt, a quantity of brown sugar, a quantity of white sugar, and a quantity of baking soda are mixed together to create a cohesive dough mixture. More specifically, the quantity of flour is mounded and then the quantity of egg white, the quantity of salt, the quantity of brown sugar, the quantity of white sugar, and the quantity of baking soda are added to the quantity of flour. Once mounding and addition of the plurality of ingredients is completed, the quantity of flour, the quantity of egg white, the quantity of salt, the quantity of brown sugar, the quantity of white sugar, and the quantity of baking soda are mixed together to yield a shaggy dough mixture. Addition of each of the plurality of ingredients to the quantity of flour can be completed simultaneously or consecutively to create the shaggy dough mixture during the mixing process. After the plurality of ingredients is mixed together, the shaggy dough mixture is continuously kneaded until the shaggy dough mixture transforms into the cohesive dough mixture. The kneading process allows the shaggy dough mixture to hold tiny air pockets, also known as carbon dioxide gas pockets. The carbon dioxide gas pockets are created by the baking soda and ensure that the cohesive dough mixture does not collapse or become a heavy/dense mixture.

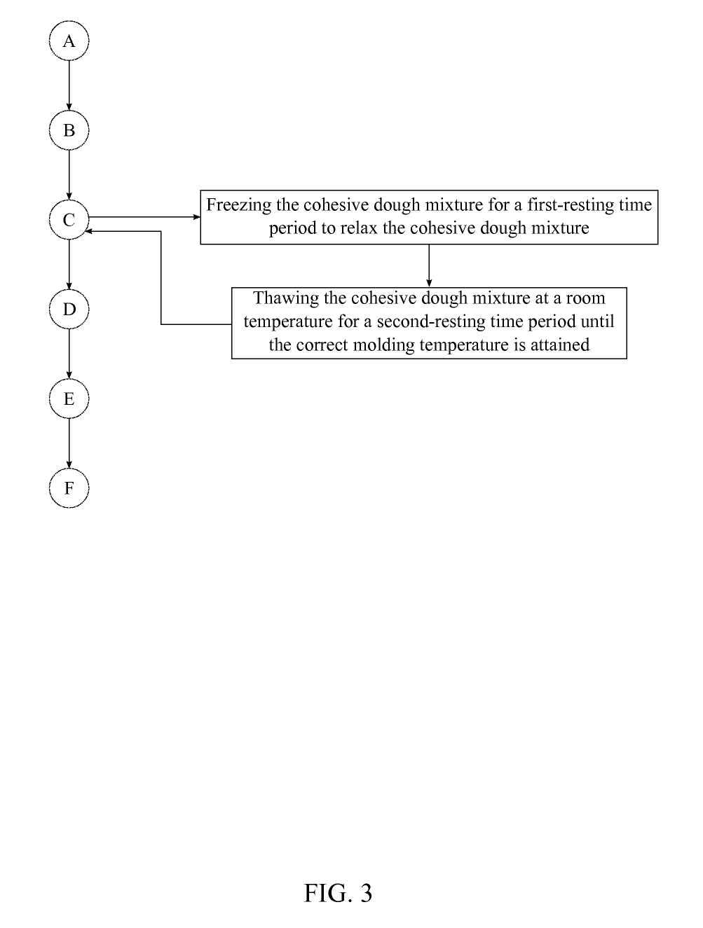

In reference to FIG. 1 and FIG. 3, the cohesive dough mixture is then rested to attain a correct molding temperature such that the smoking pipe can be easily formed. Resting process of the cohesive dough mixture is carried out by two different phases. First, the cohesive dough mixture is frozen for a first-resting time period to seal the cohesive dough mixture. More specifically, the freezing process relaxes the cohesive dough mixture into long protein chains which form the superstructure of the smoking pipe. It is also possible to achieve greater volume and lightness for the smoking pipe through the freezing process. Secondly, the cohesive dough mixture is thawed within a room temperature for a second-resting time period until the correct molding temperature is attained. The second-resting time period is preferably about 15 minutes as the correct molding temperature of the cohesive dough mixture provides the desired texture for forming the smoking pipe.

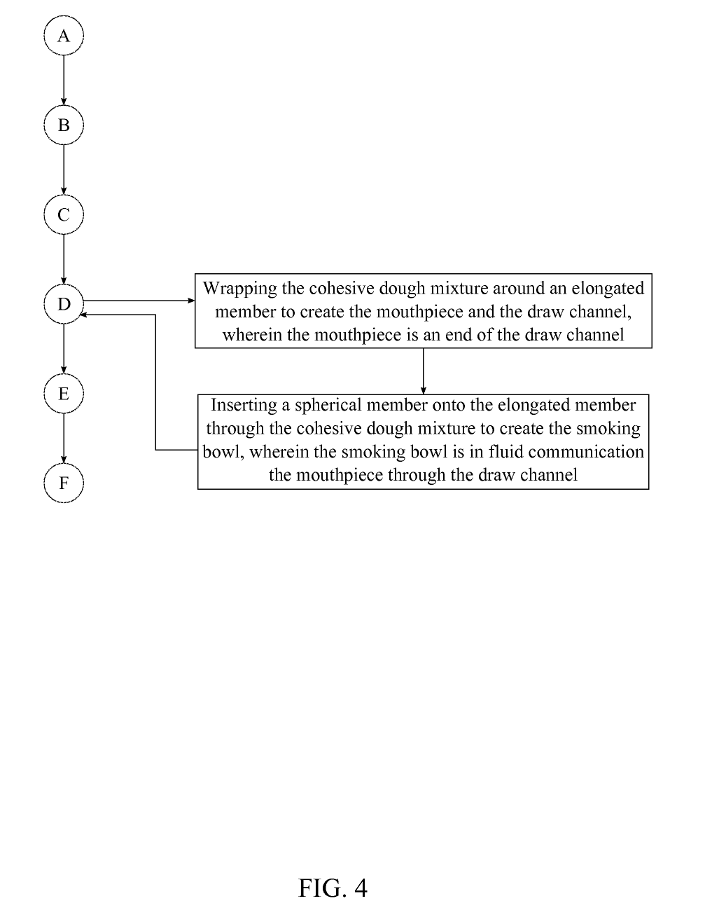

In reference to FIG. 1 and FIG. 4, the cohesive dough mixture is then formed into a desired shaped of the smoking pipe, where the smoking pipe includes a draw channel, a smoking bowl, and a mouthpiece. In reference to the forming process of the smoking pipe, the cohesive dough is first wrapped around an elongated member to create the draw channel and the mouthpiece where the mouthpiece is an end of the draw channel. Then a spherical member is inserted onto the elongated member through the cohesive dough mixture to create the smoking bowl. Since the spherical member intersects with the elongated member, the smoking bowl is able to be in fluid communication with the mouthpiece through the draw channel. The smoking bowl is formed opposite of the mouthpiece along the draw channel in such a way that configuration of the draw channel, the smoking bowl, and the mouthpiece delineates the general shape of the smoking pipe.

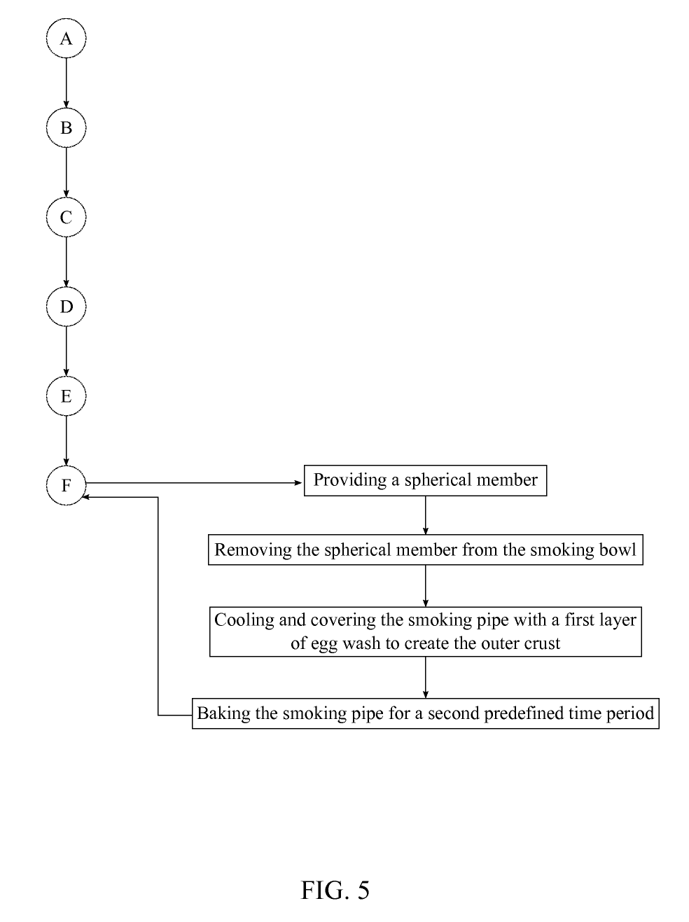

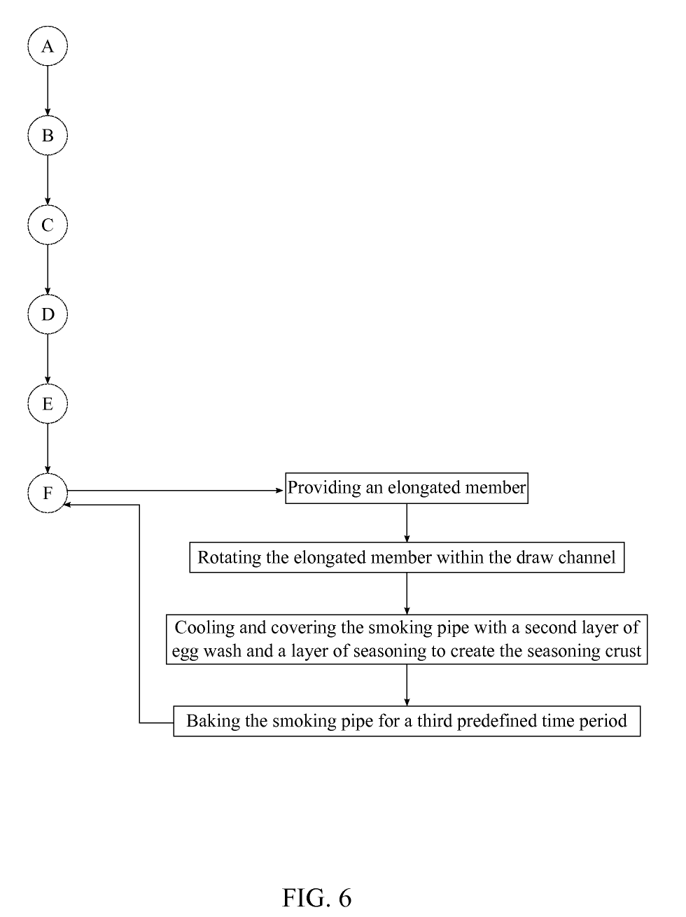

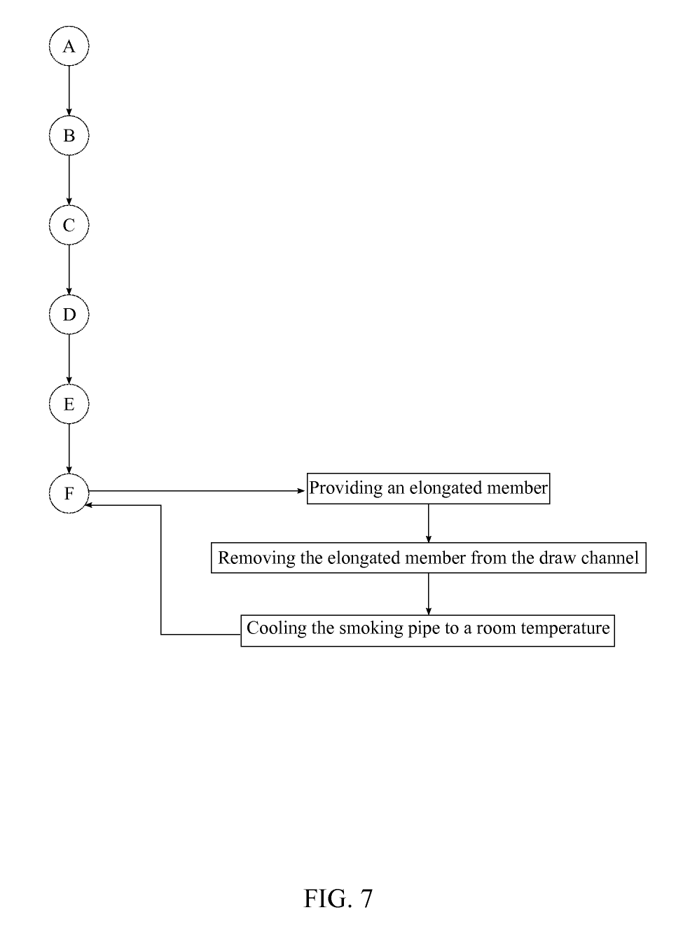

After the smoking pipe is formed, the smoking pipe is processed through a first baking phase for a first predefined time period as illustrated in FIG. 1. The first baking phase allows the smoking pipe to maintain the shape of the draw channel, the smoking bowl, and the mouthpiece so that the subsequent steps of the present invention can be easily carried out. The first predefined time period for the initial baking process is preferably about 10 minutes at a baking temperature of 350 degrees Fahrenheit. In reference to FIG. 1, once the first predefined time period is completed, the smoking pipe is intermittently cooled and baked to create an outer crust and a seasoning crust. The intermittently cooling and baking process of the smoking pipe utilizes different processing stages so that the smoking pipe can be finalized as a smoking apparatus. In reference to FIG. 5, after the first predefined time period is completed, the smoking pipe is cooled and the spherical member is removed from the smoking bowl. Then the smoking pipe is covered with a first layer of egg wash to create the outer crust and processed through a second baking phase for a second predefined time period. The second predefined time period for the second baking phase is preferably about 10 minutes at a baking temperature of 350 degrees Fahrenheit. During the second baking phase of the smoking pipe, the first layer of egg wash is caramelized and becomes the outer crust of the smoking pipe. In reference to FIG. 6, once the second predefined time period is completed for the second baking phase, the smoking pipe is cooled while the elongated member is rotated within the draw channel. The rotation of the elongated member maintains an annular shape of the draw channel and separates the elongated member from the draw channel. Then the smoking pipe is covered with a second layer of egg wash and a layer of seasoning to create the seasoning crust. The second layer of egg wash holds the layer of seasoning, preferably salt particles, about the smoking pipe. Then the seasoning crust can be developed through a third baking phase of the smoking pipe. More specifically, the third baking phase is processed at a baking temperature of 350 degrees Fahrenheit for a third predefined time period, where the third predefined time period is preferably about 15 minutes. In reference to FIG. 7, after the third predefined time period is completed, the elongated member is removed from the draw channel and the smoking pipe is cooled to a room temperature as the final steps. Then the smoking pipe can be utilized as the smoking apparatus for smoking loose herbs and tobacco products.

Although the invention has been explained in relation to its preferred embodiment, it is to be understood that many other possible modifications and variations can be made without departing from the spirit and scope of the invention as hereinafter claimed.

What is claimed is:

1. A method of manufacturing an inexpensive and disposable smoking pipe, the method comprises the steps of:
(A) providing a plurality of ingredients;
(B) mixing the plurality of ingredients together to create a cohesive dough mixture;
(C) resting the cohesive dough mixture to attain a correct molding temperature to form a smoking pipe;
(D) forming the cohesive dough mixture into the smoking pipe, wherein the smoking pipe includes a draw channel, a smoking bowl, and a mouthpiece;
(E) baking the smoking pipe for a first predefined time period to maintain the shape of the draw channel, the smoking bowl, and the mouthpiece; and
(F) intermittently cooling and baking the smoking pipe to create an outer crust and a seasoning crust.

2. The method of manufacturing an inexpensive and disposable smoking pipe, the method as claimed in claim 1 comprises the steps of:
providing a quantity of flour, a quantity of egg white, a quantity of salt, a quantity of brown sugar, a quantity of white sugar, and a quantity of baking soda to the quantity of flour as the plurality of ingredients;
mounding the quantity of flour;
adding the quantity of egg white, the quantity of salt, the quantity of brown sugar, the quantity of white sugar, and the quantity of baking soda to the quantity of flour;
mixing the quantity of flour, the quantity of egg white, the quantity of salt, the quantity of brown sugar, the quantity of white sugar, and the quantity of baking soda together to yield a shaggy dough mixture; and
continuously kneading the shaggy dough mixture until the shaggy dough mixture transform into the cohesive dough mixture.

3. The method of manufacturing an inexpensive and disposable smoking pipe, the method as claimed in claim 1 comprises the steps of:
freezing the cohesive dough mixture for a first-resting time period to relax the cohesive dough mixture; and
thawing the cohesive dough mixture at a room temperature for a second-resting time period until the correct molding temperature is attained.

4. The method of manufacturing an inexpensive and disposable smoking pipe, the method as claimed in claim 1 comprises the steps of:
wrapping the cohesive dough mixture around an elongated member to create the mouthpiece and the draw channel, wherein the mouthpiece is an end of the draw channel; and
inserting a spherical member onto the elongated member through the cohesive dough mixture to create the smoking bowl, wherein the smoking bowl is in fluid communication the mouthpiece through the draw channel.

5. The method of manufacturing an inexpensive and disposable smoking pipe, the method as claimed in claim 1 comprises the steps of:
providing a spherical member;
removing the spherical member from the smoking bowl;
cooling and covering the smoking pipe with a first layer of egg wash to create the outer crust; and
baking the smoking pipe for a second predefined time period.

6. The method of manufacturing an inexpensive and disposable smoking pipe, the method as claimed in claim 1 comprises the steps of:
providing an elongated member;
rotating the elongated member within the draw channel;
cooling and covering the smoking pipe with a second layer of egg wash and a layer of seasoning to create the seasoning crust; and
baking the smoking pipe for a third predefined time period.

7. The method of manufacturing an inexpensive and disposable smoking pipe, the method as claimed in claim 1 comprises the steps of:
providing an elongated member;
removing the elongated member from the draw channel; and
cooling the smoking pipe to a room temperature.
